(19) United States
(12) Patent Application Publication
(10) Pub. No.: US 2026/0117825 A1
(43) Pub. Date: Apr. 30, 2026

(54) UNIVERSAL JOINT FOR A VEHICLE

(71) Applicants: HYUNDAI MOTOR COMPANY, Seoul (KR); KIA CORPORATION, Seoul (KR)

(72) Inventor: Dae Suk Jung, Hwaseong-si (KR)

(73) Assignees: HYUNDAI MOTOR COMPANY, Seoul (KR); KIA CORPORATION, Seoul (KR)

(21) Appl. No.: 19/204,134

(22) Filed: May 9, 2025

(30) Foreign Application Priority Data
Oct. 30, 2024 (KR) 10-2024-0150583

(51) Int. Cl. F16D 3/223; B62D 1/19; B62D 1/20

(52) U.S. Cl. CPC F16D 3/223; B62D 1/192; B62D 1/20

(57) ABSTRACT

A universal joint includes a hollow tube, a shaft having one end inserted into one side of the tube, and a first yoke connected to the other-side end of the tube. The first yoke has a through-hole formed to communicate with a hollow interior of the tube. An inner diameter or inner width of the through-hole is at least greater than an outer diameter or outer width of the shaft.

### CROSS-REFERENCE TO RELATED APPLICATION(S)

This application claims benefit of and priority to Korean Patent Application No. 10-2024-0150583, filed on Oct. 30, 2024 in the Korean Intellectual Property Office, the disclosure of which is incorporated herein by reference in its entirety.

### TECHNICAL FIELD

The present disclosure relates to a universal joint for a vehicle having improved collision performance.

### BACKGROUND

A universal joint may be applied to a steering apparatus of a vehicle. The universal joint may transmit rotational torque of a steering column from a steering wheel to a steering gear, and may prevent deformation of the steering column by blocking transmission of an impact load caused by collapse occurring when the steering gear moves upwardly due to collision of a vehicle.

When the steering column and the steering gear are close to each other and the length of the universal joint is short, an amount of collapse of the universal joint may be physically reduced in the even of a vehicle collision. Accordingly, the universal joint may not sufficiently absorb upward and rearward movement of the steering gear and push up the steering column.

In this case, a bending load may be generated in the steering column. Accordingly, a collapse function of the steering column itself may not operate properly to absorb the impact load, and at the same time, the steering column may tilt downwardly, which may change a deployment position of an airbag, thereby degrading a protective function of the airbag. As a result, driver injuries may increase.

The statements in this section merely provide background information related to the present disclosure and may not constitute prior art.

### SUMMARY

Aspects of the present disclosure provide a universal joint for a vehicle having improved collision performance by increasing an amount of collapse of the universal joint.

According to an aspect of the present disclosure, a universal joint includes: a tube including a first end and a second end which is opposite to the first end; a shaft having a first end inserted into the first end of the tube; and a first yoke connected to the second (i.e., the opposite) end of the tube. The first yoke may have a through-hole formed to communicate with a hollow interior of the tube. In particular, an inner diameter or inner width of the through-hole may be at least greater than an outer diameter or outer width of the shaft.

The tube and the first yoke may be fixedly coupled to each other, or may be integrally molded.

The through-hole may be formed in the first yoke to coaxially communicate with the hollow interior in a longitudinal direction of the tube, and has a cross-sectional shape corresponding to a cross-sectional shape of the shaft.

The shaft may be slidably movable relative to the tube, in a longitudinal direction of the tube, in the hollow interior, and the shaft may be fixed relative to the tube in a circumferential direction of the tube.

The universal joint may further include a hollow slip bush interposed between the tube and the shaft.

The hollow slip bush may include a plurality of rotating members arranged in an axial direction of the hollow slip bush, and the plurality of rotating members are disposed in a plurality of rows, spaced apart from each other in a circumferential direction of the hollow slip bush. A plurality of guide grooves may be formed, along a longitudinal direction of the tube, on each of an outer circumferential surface of the shaft and an inner circumferential surface of the tube. The rotating member may be seated in the guide grooves.

When a collapse occurs in the universal joint, the hollow slip bush may be constrained from moving, at least by an end portion of the guide grooves of the tube, toward the first yoke.

A ring stopper may be mounted on an outer circumferential surface of one end of the shaft to prevent separation of the hollow slip bush.

An inner diameter of the through-hole may be greater than an outer diameter of the ring stopper.

The universal joint may further include a first pinch yoke coupled to the first yoke via a first spider, and a cap fixedly installed at the first end (e.g., one-side end) of the tube.

The universal joint may further include a second yoke connected to a second end of the shaft, and a second pinch yoke coupled to the second yoke via a second spider.

The universal joint may have an amount of collapse of the shaft, allowing movement until the cap comes into contact with the second yoke, and an amount of collapse of the tube, allowing movement until the first end of the shaft passes through the tube and the first yoke and reaches the first spider.

The universal joint may be applied to a steering apparatus of a vehicle including a steering column and a steering gear. The first pinch yoke may be coupled to an output shaft of the steering gear, and the second pinch yoke may be coupled to an input shaft of the steering column.

The first end of the shaft is configured to pass through the tube and the through-hole of the first yoke when an external force applies to the shaft.

In another embodiment, a universal joint comprises: a tube including a first end, a second end, and a hollow interior extending along a longitudinal direction of the tube; a shaft configured to move within the hollow interior of the tube along the longitudinal direction; a first yoke fixedly connected to the second end of the tube; and a second yoke fixedly connected to the shaft on a side opposite side to the first yoke. In particular, the first yoke includes a through-hole connected to the hollow interior of the tube, and one end of the shaft is configured to pass through the tube and the through-hole of the first yoke when an external force applies to the shaft. The universal joint further comprises a hollow slip bush interposed between the tube and the shaft, and the hollow slip bush includes a plurality of rotating members arranged in an axial direction of the hollow slip bush. The plurality of rotating members is seated in a plurality of guide grooves formed, along a longitudinal direction of the tube, on each of an outer circumferential surface of the shaft and an inner circumferential surface of the tube. In particular, the shaft is slidably movable relative to the tube via the hollow slip bush, along the longitudinal direction of the tube, and the shaft is fixed relative to the tube in a circumferential direction of the tube via the plurality of guide grooves formed along a longitudinal direction of the tube.

According to example embodiments of the present disclosure, an amount of collapse of a universal joint may be increased even in a limited situation, thereby obtaining an effect of reliably securing collision performance.

In addition, according to example embodiments of the present disclosure, changes to peripheral components may be unnecessary, and collision performance may be improved while costing the same as the related art.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a schematic diagram illustrating a steering apparatus of a vehicle to which a universal joint according to an embodiment of the present disclosure is applied;

FIG. 2 is a diagram illustrating a universal joint according to an embodiment of the present disclosure;

FIGS. 3A and 3B are diagrams illustrating examples of combinations of a tube and a first yoke; and

FIG. 4 is a diagram illustrating a state in which a universal joint, according to an embodiment of the present disclosure, is operated after collision of a vehicle.

The drawings described herein are for illustration purposes only and are not intended to limit the scope of the present disclosure in any way.

### DETAILED DESCRIPTION

Hereinafter, the present disclosure is described in detail with reference to exemplary drawings. In adding reference numerals to components of each drawing, it should be noted that the same components are indicated by the same numerals even though displayed on different drawings.

The terms, such as first, second, A, B, (a), (b), and the like, may be used herein to describe components. Each of the terms is not used to define an essence, order or sequence of a corresponding component but used merely to distinguish a corresponding component from other component(s).

As used herein, the terms, such as “upper (top),” “lower (bottom),” “front (forward),” “rear (backward),” and the like, used in relation to direction are defined based on a vehicle body or an installation target.

When a component, device, element, or the like of the present disclosure is described as having a purpose or performing an operation, function, or the like, the component, device, or element should be considered herein as being “configured to” meet that purpose or to perform that operation or function.

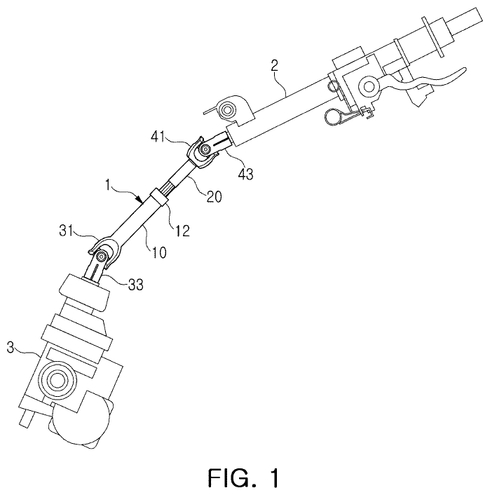

FIG. 1 is a schematic diagram illustrating a steering apparatus of a vehicle to which a universal joint according to an embodiment of the present disclosure is applied.

When a driver of a vehicle rotates a steering wheel (not illustrated) in a desired direction, a steering column 2, connected to the steering wheel, may rotate, and the steering column may transmit rotational force, (i.e., rotational torque) to a steering gear 3 through a universal joint 1. The steering gear 3 may include a rack and pinion gear.

The steering gear 3 may convert a rotational motion of the steering column 2 into a linear motion by the rack and pinion gear, and may transmit the rotational motion to a rack bar. The rack bar may transmit force to a tie rod, which is connected to a knuckle of the wheel, to change a direction of the vehicle's movement.

As illustrated in FIG. 1, an input shaft of the steering column 2, which transmits the rotational force, and an output shaft of the steering gear 3, which receives the rotational force, may not be coaxially aligned with each other, but may be disposed to be inclined at a predetermined angle.

Accordingly, the rotational force between the steering column 2 and the steering gear 3 may not be transmitted using a general shaft coupling method, such that it may be desired to use the universal joint 1 capable of connecting two inclined axes and transmitting power.

One end of the universal joint 1 may be bent at a predetermined angle and connected to the steering column 2, which is linked to the steering wheel. The other end of the universal joint 1 may be bent at a predetermined angle and connected to the steering gear 3. Accordingly, the universal joint may transmit rotational torque of the steering column, generated in the steering wheel, to the steering gear.

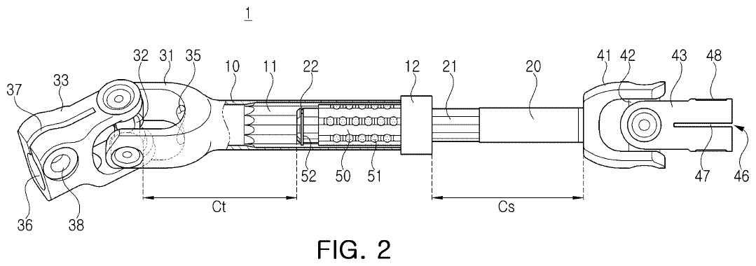

FIG. 2 is a diagram illustrating a universal joint according to an embodiment of the present disclosure.

As illustrated in FIG. 2, the universal joint 1 according to an embodiment of the present disclosure may include a tube 10, a shaft 20, and a first yoke 31.

The tube 10 may have a hollow interior extending along its a longitudinal direction. The shaft 20 may be assembled within the tube 10 to be slidably movable.

The shaft 20 may have one end inserted into a first end (e.g., one side end) of the tube 10, and thus may be slidably movable, relative to the tube in the longitudinal direction, in the hollow interior. However, the shaft 20 may be fixed to the tube 10 in a circumferential direction of the tube, and thus may not rotate relative to the tube 10.

With this configuration, when the tube 10 and the shaft 20 are assembled, a length change of the universal joint 1 may be compensated or an input load may be absorbed, and rotational torque without sliding relative to each other may be accurately transmitted.

For example, a convex spline or a convex serration may be formed on an outer circumferential surface of the shaft 20 to be elongated in the longitudinal direction, and a concave spline or a concave serration, engaging with the convex spline or the convex serration of the shaft, may be formed on an inner circumferential surface of the tube 10 to be elongated in the longitudinal direction.

The tube 10 and the shaft 20 may be spline-connected or serration-connected to each other, and thus the shaft may be slidably movable in the longitudinal direction in the hollow interior of the tube and may not rotate in the circumferential direction. As a result, the tube and the shaft may form a slip joint.

In another embodiment of the present disclosure, the universal joint may further include a hollow slip bush 50 interposed between the tube 10 and the shaft 20. To this end, guide grooves 11 and 21 may be respectively formed in an outer circumferential surface of the shaft and an inner circumferential surface of the tube to be elongated in the longitudinal direction. A rotating member 51 of the slip bush may be mounted in the guide grooves.

The slip bush 50 may be formed in a hollow tubular shape and inserted between the tube 10 and the shaft 20. For example, the slip bush may be formed of a plastic material having rigidity and wear resistance, but is not limited thereto. In an embodiment, the slip bush 50 may include a plurality of rotating members 51 passing through the slip bush, and the plurality of rotating members 51 may be arranged in an axial direction of the slip bush and may be disposed in a plurality of rows spaced apart from each other in a circumferential direction of the slip bush. The rotating member may be, for example, a spherical ball member or a cylindrical roller member.

The inside of each rotating member 51 may protrude toward the outer circumferential surface of the shaft 20 and may be accommodated in the guide groove 21 of the shaft. The outside of each rotating member 51 may protrude toward the inner circumferential surface of the tube 10 and may be accommodated in the guide grooves 11 of the tube.

With this configuration, the plurality of rotating members 51 may come into contact with the outer circumferential surface of the shaft 20 and the inner circumferential surface of the tube 10, thereby minimizing friction occurring when the shaft slidably moves, in the longitudinal direction, into the tube, and accurately transmitting rotational torque, applied to the shaft, to the tube due to the plurality of rotating members 51 which are caught in a rotational direction in the guide groove 21 of the shaft and the guide grooves 11 of the tube.

A ring stopper 52 may be mounted on an outer circumferential surface of one end of the shaft 20 to prevent separation of the slip bush 50. To this end, a ring groove 22 in which the ring stopper is seated may be formed in the outer circumferential surface of the one end of the shaft.

In addition, when the shaft and slip bush are inserted into the hollow interior of the tube 10 after the slip bush 50 is mounted on the outer circumferential surface of the shaft 20, a cap 12 may be fixedly installed at the first end (e.g., one-side end) of the tube, thereby completing assembly of the slip joint.

The first yoke 31 may be connected to a second end (e.g., the other-side end) of the tube 10, i.e., an end of the tube 10 opposite to the shaft 20. The first yoke may substantially have a U-shape, with a pair of yoke ends branching into two sections. For example, the pair of yoke ends extend into two branches. Two ends of a first spider 32, having a cross (+) shape, may be rotatably connected to the inside of the pair of yoke ends.

According to an embodiment of the present disclosure, the universal joint 1 may further include a first pinch yoke 33 coupled to the first yoke 31 via the first spider 32.

The first pinch yoke 33 may include a pair of pinch yoke ends which extend into two branches, and the pair of yoke ends of the first yoke 31 and the pair of pinch yoke ends may be disposed to be staggered from each other. In other words, the pair of yoke ends of the first yoke 31 and the pair of pinch yoke ends may be offset from each other in a staggered configuration. Remaining two ends of the first spider 32, which is coupled to the inside of the pair of yoke ends, may be rotatably connected to the inside of the pair of pinch yoke ends.

The first spider 32 has four ends extending in a cross (+) shape. Among the four ends of the first spider 32, a first pair of ends, disposed at 180 degrees with respect to each other (i.e., positioned 180 degrees apart from each other), may be hingedly connected to the inside of the yoke ends of the first yoke 31. A second pair of ends, disposed at 180 degrees with respect to each other (i.e., positioned 180 degrees apart from each other), may be hingedly connected to the inside of the pinch yoke ends of the first pinch yoke 33.

With this configuration, the first yoke 31 and the first pinch yoke 33, coupled to each other via the first spider 32, may form a first yoke joint.

In an embodiment of the present disclosure, the universal joint 1 may further include a second yoke 41 connected to the other end of the shaft 20, and a second pinch yoke 43 coupled to the second yoke via a second spider 42.

The second yoke 41 may be connected to an end of the shaft 20 opposite to the tube 10. The second yoke may substantially have a U-shape, with a pair of yoke ends branching into two sections. For example, the pair of yoke ends extend into two branches. Two ends of the second spider 42, having a cross (+) shape, may be rotatably connected to the inside of the pair of yoke ends.

The second pinch yoke 43 may include a pair of pinch yoke ends which extend into two branches, and the pair of yoke ends of the second yoke 41 and the pair of pinch yoke ends may be disposed to be staggered from each other. Remaining two ends of the second spider 42, which is coupled to the inside of the pair of yoke ends, may be rotatably connected to the inside of the pair of pinch yoke ends.

The second spider 42 has four ends extending in a cross (+) shape. Among the four ends of the second spider 42, a first pair of ends, disposed at 180 degrees with respect to each other, may be hingedly connected to the inside of the yoke ends of the second yoke 41. A second pair of ends, disposed at 180 degrees with respect to each other, may be hingedly connected to the inside of the pinch yoke ends of the second pinch yoke 43.

With this configuration, the second yoke 41 and the second pinch yoke 43, coupled to each other via the second spider 42, may form a second yoke joint.

The first pinch yoke 33 and the second pinch yoke 43 may respectively include shaft connection holes 36 and 46 to which an input shaft or an output shaft is connected; slit cutting portions 37 and 47 having a slit shape to communicate with the shaft connection holes; and fastening holes 38 and 48 orthogonal to the slit cutting portions and formed to communicate with the slit cutting portions.

A bolt and nut may be fastened to the fastening holes 38 and 48, but the present disclosure is not limited thereto. For example, when a thread is formed on an inner circumferential surface of the fastening hole, a screw may be fastened. Here, the bolt and nut, the screw, and the like may be collectively referred to as a fastener.

When the fastener is fastened through the fastening holes 38 and 48 after an end of the input shaft or an end of the output shaft is inserted into the shaft connection holes 36 and 46, the slit cutting parts 37 and 47 may be deformed, such that an outer circumferential surface of the end of the input shaft or the output shaft may be tightened. As a result, the input shaft or the output shaft may be firmly fixed to a corresponding pinch yoke 33 or 43.

For example, an output shaft of the steering gear 3 may be coupled to the first pinch yoke 33, while an input shaft of the steering column 2 may be coupled to the second pinch yoke 43, but the present disclosure is not limited thereto. For example, the output shaft of the steering gear 3 may be coupled to the second pinch yoke 43, while the input shaft of the steering column 2 may be coupled to the first pinch yoke 33.

The universal joint 1 according to an embodiment of the present disclosure may have a through-hole 35 formed to allow the first yoke 31 to communicate with the hollow interior of the tube 10, and an inner diameter of the through-hole may be at least greater than an outer diameter of the shaft 20.

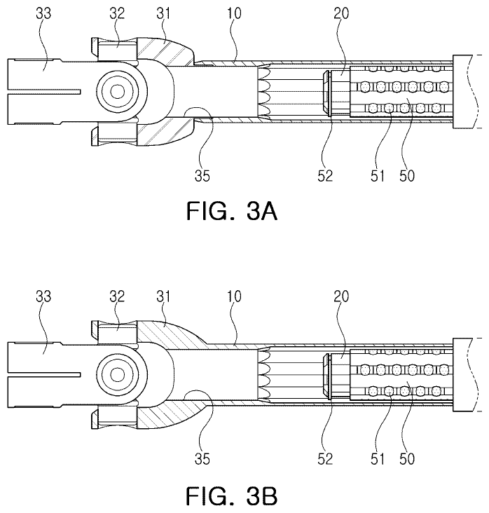

FIGS. 3A and 3B are diagrams illustrating examples of combinations of a tube and a first yoke.

In the universal joint 1 according to an embodiment of the present disclosure, the tube 10 and the first yoke 31 coupled thereto may be manufactured separately and then fixedly coupled to each other using a method such as welding, screw fastening, or the like, as illustrated in FIG. 3A.

In another embodiment, the tube 10 and the first yoke 31 coupled thereto may be integrally molded using a method such as insert injection or the like, as illustrated in FIG. 3B. In this case, the number of processes for each component may be reduced.

Regardless of a method in which the tube 10 and the first yoke 31 are coupled to each other, a through-hole 35, capable of coaxially communicating with the hollow interior of the tube in a longitudinal direction of the tube 10, may be formed in the first yoke 31 of the universal joint 1 according to an embodiment of the present disclosure, and the through-hole 35 may have an inner diameter, which is at least greater than an outer diameter of the shaft 20.

For example, when the universal joint 1 includes a hollow slip bush 50 interposed between the tube 10 and the shaft 20, the ring stopper 52 may be mounted on an outer circumferential surface of one end of the shaft. The ring stopper 52 may protrude radially from the outer circumferential surface of the one end of the shaft. Thus, the through-hole 35 of the first yoke 31 may have an inner diameter greater than or equal to an outer diameter of the ring stopper.

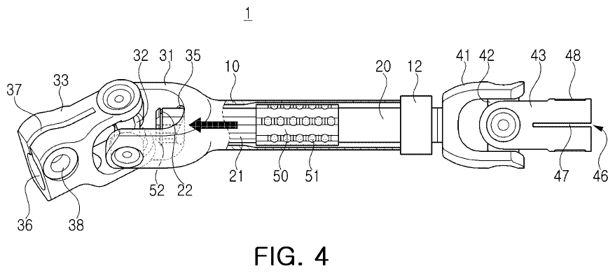

FIG. 4 is a diagram illustrating a state in which a universal joint according to an embodiment of the present disclosure is operated after collision of a vehicle.

The universal joint 1 may secure an amount of collapse (Cs) of the shaft, allowing movement until the cap 12 installed on the tube 10 comes into contact with the second yoke 41 of the shaft 20, and an amount of collapse (Ct) of the tube, permitting movement until one end of the shaft passes through the tube and the first yoke 31 and reaches the first spider 32.

When a collapse occurs in the universal joint 1 simultaneously with the steering gear 3 moving upwardly due to collision of a vehicle, one end of the shaft 20 may entirely pass through the tube 10 and then pass through the through-hole 35 of the first yoke 31 to reach the first spider 32 forming a first yoke joint or a vicinity thereof, such that the universal joint 1 may maximize the amount of collapse (Ct) of the tube. As a result, a total amount of collapse may be significantly increased.

In a universal joint according to the related art, an amount of collapse of a tube is set as a distance at which one end of a shaft comes into contact with a first yoke of the tube. However, in the universal joint 1 according to an example embodiment of the present disclosure, one end of the shaft 20 may pass through the first yoke 31 of the tube 10 and reach the first spider 32, thereby increasing the amount of collapse (Ct) of the tube compared to that in the related art.

The universal joint 1 may include a hollow slip bush 50 interposed between the tube 10 and the shaft 20. When a collapse occurs in the universal joint due to collision of a vehicle, the slip bush 50 may be positioned between an end of the guide groove 11 of the tube toward the first yoke 31 and an end of the guide groove 21 of the shaft toward the second yoke 41.

In other words, when a collapse occurs in the universal joint 1 due to collision of a vehicle, the slip bush 50 may be stopped from moving at least by the end of the guide groove 11 of the tube toward the first yoke 31.

The universal joint 1 according to the present disclosure was mounted on a vehicle, and the collision performance of the universal joint was evaluated. In front collision of the vehicle, an amount of collapse of the universal joint according to the present disclosure and the related art, and a chest acceleration (unit gravitational acceleration g) of a driver were compared to each other.

As a result of the evaluation, the amount of collapse of the universal joint 1 according to the present disclosure was increased by about 33 mm, as compared to that in the related art. In addition, a chest acceleration in the related art was 90.6%, which is close to a target value. However, in the universal joint according to the present disclosure, a chest acceleration was reduced to 75%, from which it may be confirmed that collision performance is improved under a condition of an equivalent collision load.

As described above, according to embodiments of the present disclosure, an amount of collapse of a universal joint may be increased even in a limited situation, thereby obtaining an effect of reliably securing collision performance.

In addition, according to embodiments of the present disclosure, changes to peripheral components may be unnecessary, and collision performance may be improved while costing the same as the related art.

While embodiments have been illustrated and described above, it should be apparent to those having ordinary skill in the art that modifications and variations could be made without departing from the scope of the present disclosure as defined by the appended claims.

For example, as described herein, the present disclosure is described with a tube and a shaft having a circular cross-sectional shape, but the present disclosure is not limited thereto, and a principle of the present disclosure may be applied to a tube and a shaft having a polygonal cross-sectional shape, for example a rectangular shape or the like.

In this case, a through-hole may have a polygonal cross-sectional shape corresponding to the cross-sectional shape of the shaft, and an inner width of the through-hole may be greater than an outer width of the shaft.

The embodiments described herein are to be considered in a descriptive sense only, and not for purposes of limitation. Therefore, the scope of the present disclosure is defined not by the detailed description, but by the claims and their equivalents, and all variations within the scope of the claims and their equivalents are to be construed as being included in the present disclosure.

What is claimed is:

1. A universal joint comprising:
a tube including a first end and a second end;
a shaft having a first end inserted into the first end of the tube; and
a first yoke connected to the second end of the tube,
wherein the first yoke has a through-hole formed to communicate with a hollow interior of the tube, and
wherein an inner diameter or inner width of the through-hole is at least greater than an outer diameter or outer width of the shaft.

2. The universal joint of claim 1, wherein the tube and the first yoke are fixedly coupled to each other or integrally molded.

3. The universal joint of claim 2, wherein the through-hole is formed in the first yoke to coaxially communicate with the hollow interior in a longitudinal direction of the tube, and has a cross-sectional shape corresponding to a cross-sectional shape of the shaft.

4. The universal joint of claim 1, wherein the shaft is slidably movable relative to the tube, in a longitudinal direction of the tube, in the hollow interior, and the shaft is fixed relative to the tube in a circumferential direction of the tube.

5. The universal joint of claim 4, further comprising:
a hollow slip bush interposed between the tube and the shaft.

6. The universal joint of claim 5, wherein
the hollow slip bush includes a plurality of rotating members arranged in an axial direction of the hollow slip bush,
wherein the plurality of rotating members are disposed in a plurality of rows, spaced apart from each other in a circumferential direction of the hollow slip bush, and
wherein a plurality of guide grooves is formed, along a longitudinal direction of the tube, on each of an outer circumferential surface of the shaft and an inner circumferential surface of the tube, and the plurality of rotating members are seated in the plurality of guide grooves.

7. The universal joint of claim 6, wherein, when a collapse occurs in the universal joint, the hollow slip bush is constrained from moving, at least by an end portion of the plurality of guide grooves of the tube, toward the first yoke.

8. The universal joint of claim 5, wherein a ring stopper is mounted on an outer circumferential surface of one end of the shaft to prevent separation of the hollow slip bush.

9. The universal joint of claim 8, wherein an inner diameter of the through-hole is greater than an outer diameter of the ring stopper.

10. The universal joint of claim 1, further comprising:
a first pinch yoke coupled to the first yoke via a first spider; and
a cap fixedly installed at the first end of the tube.

11. The universal joint of claim 10, further comprising:
a second yoke connected to a second end of the shaft; and
a second pinch yoke coupled to the second yoke via a second spider.

12. The universal joint of claim 11, wherein the universal joint has an amount of collapse of the shaft, allowing movement until the cap comes into contact with the second yoke.

13. The universal joint of claim 11, wherein the universal joint has an amount of collapse of the tube, allowing movement until the first end of the shaft passes through the tube and the first yoke and reaches the first spider.

14. The universal joint of claim 11, wherein
the universal joint is applied to a steering apparatus of a vehicle including a steering column and a steering gear, and
the first pinch yoke is coupled to an output shaft of the steering gear, and the second pinch yoke is coupled to an input shaft of the steering column.

15. The universal joint of claim 1, wherein the first end of the shaft is configured to pass through the tube and the through-hole of the first yoke when an external force applies to the shaft.

16. A universal joint comprising:
a tube including a first end, a second end, and a hollow interior extending along a longitudinal direction of the tube;
a shaft configured to move within the hollow interior of the tube along the longitudinal direction;
a first yoke fixedly connected to the second end of the tube; and
a second yoke fixedly connected to the shaft on a side opposite side to the first yoke,
wherein the first yoke includes a through-hole connected to the hollow interior of the tube, and
wherein one end of the shaft is configured to pass through the tube and the through-hole of the first yoke when an external force applies to the shaft.

17. The universal joint of claim 16, wherein the shaft is slidably movable relative to the tube, along the longitudinal direction of the tube, and the shaft is fixed relative to the tube in a circumferential direction of the tube.

18. The universal joint of claim 16, further comprising a hollow slip bush interposed between the tube and the shaft and including a plurality of rotating members arranged in an axial direction of the hollow slip bush,
wherein the plurality of rotating members is seated in a plurality of guide grooves formed, along a longitudinal direction of the tube, on each of an outer circumferential surface of the shaft and an inner circumferential surface of the tube.

19. The universal joint of claim 18, wherein the shaft is slidably movable relative to the tube via the hollow slip bush, along the longitudinal direction of the tube, and
wherein the shaft is fixed relative to the tube in a circumferential direction of the tube via the plurality of guide grooves formed along a longitudinal direction of the tube.
